(19) United States
(12) Patent Application Publication
(10) Pub. No.: US 2025/0306190 A1
(43) Pub. Date: Oct. 2, 2025

(54) ACOUSTIC VECTOR SENSOR

(71) Applicant: Raytheon Company, Tewksbury, MA (US)

(72) Inventors: Julian Winkler, Glastonbury, CT (US); Kenji Homma, Glastonbury, CT (US); Jeffrey M. Mendoza, Manchester, CT (US); Jason E. Gaudette, Portsmouth, RI (US); Kevin P. Bongiovanni, Portsmouth, RI (US); Jeffrey L. Cipolla, Little Compton, RI (US)

(21) Appl. No.: 18/624,901

(22) Filed: Apr. 2, 2024

(51) Int. Cl. G01S 7/521; G01S 7/539; G01S 15/58

(52) U.S. Cl. CPC G01S 7/521; G01S 7/539; G01S 15/588

(57) ABSTRACT

A device optionally includes a housing defining a cavity extending through the housing. The device includes, for example, a first sensing membrane having a first deflectable surface that deflects in response to a pressure wave and a second sensing membrane spaced from the first membrane having a second deflectable surface that deflects in response to a pressure wave and connected with the housing. A device includes a coupling positioned between the first membrane and the second membrane. The coupling is configured to transmit a representation of the deflection of one or more of the membranes. A device optionally includes a sensor in communication with one or more of the first membrane, the second membrane or the coupling.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raytheon Technologies. All Rights Reserved.

### TECHNICAL FIELD

This document pertains generally, but not by way of limitation a vector sensor defining a cavity extending through the housing and including a first sensing membrane and a second sensing membrane and a coupling positioned between the first membrane and the second membrane, the coupling in communication with the first membrane with the second membrane and a sensor configured to monitor a representation of deflection of one or more of the first membrane and second membrane

### BACKGROUND

Hydrophones are an example of devices designed to detect and record underwater sound waves. Hydrophones capture a wide range of sounds across a wide range of wavelengths. They are sometimes used for understanding and monitoring the underwater environment, helping scientists and researchers gather valuable data about oceanic conditions, marine life, and geological phenomena. Hydrophones are, for example, standalone devices or arrays of devices. Hydrophones are primarily designed for the passive reception of underwater sounds.

Devices such as microphones also detect sound waves. In some examples, a microphone contains a diaphragm that vibrates in response to changes in air pressure, such as by pressure waves. This movement generates an electrical signal that in some examples is amplified and processed to reproduce the original sound. Optionally, various technologies such as piezoelectric sensors, transducers or the like are designed to convert pressure waves, or acoustic energy into electrical signals for measurement or detecting direction.

Sonar (Sound Navigation and Ranging) includes both active and passive systems that use sound waves to detect, locate, and measure the distance to underwater objects. Two types of sonar include active sonar, where a device emits pulses of sound and detects the returning echoes, and passive sonar, that listens to natural sounds of the environment.

### Overview

The present inventors have recognized that a problem to be solved includes using a singular device to measure components of pressure waves more accurately while minimizing size of the system. Pressure waves are characterized by regions of compression and rarefaction, where particles are pushed together (compression) and then spread apart (rarefaction). In examples, a vector sensor is used to measure pressure and motion components of pressure waves.

Vector sensors provide additional information about the direction of acoustic signals. Vector sensors consist of, for example, multiple elements oriented in specific directions to capture both the scalar (acoustic pressure) and vector (acoustic particle velocity) components of a pressure wave field. Data from vector sensors, are used in some situations to gain insights into the source, characteristics, and location of sounds since the vector orientation of acoustic particle velocity is in the direction of the sound wave propagation. In an example, the vector sensor senses the particle motion in terms of displacement, velocity or acceleration, depending on the design.

A vector sensor including at least two external membranes coupled to one shared internal cavity is used, for example, to detect the directionality of a pressure wave, such as a sound wave. For instance, the membranes are coupled together and the responses of membrane are accumulated. The membrane response is, optionally, a detectable function that varies as a function of the directionality of the pressure wave, such as a sound angle.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A and 1B are examples of a vector sensor according to at least one example of the present disclosure.

FIGS. 2A and 2B are cross sections of a vector sensor according to at least one example of the present disclosure.

FIGS. 3A-3G are examples of cross sections of a vector sensor with deflection-sensing elements according to at least one example of the present disclosure.

FIGS. 4A-4D are examples of cavities within a vector sensor according to at least one example of the present disclosure.

FIGS. 5A and 5B examples of multiple channel vector sensors according to at least one example of the present disclosure.

FIGS. 6A and 6B are examples of deflections of the membranes of a vector sensor according to at least one example of the present disclosure.

FIG. 7 is an example of vector sensors on a submersible system according to at least one example of the present disclosure.

FIG. 8 is an example of vector sensors on an aquatic system according to at least one example of the present disclosure.

FIG. 9 is an example of vector sensors on an aeronautic system according to at least one example of the present disclosure.

### DETAILED DESCRIPTION

Sonar systems are used to detect pressure waves, such as sound wave or acoustic signals. Sonar includes, for example, active and passive systems that use pressure waves (e.g., sound waves, acoustic signals) to detect, locate, and measure the distance to underwater objects. In some examples, to detect the directional aspects of low frequency acoustic signals, the sonar system used includes large apertures to receive the low frequency wavelengths. In some examples, the wavelengths measured are greater than 1 meter for frequencies less than 1.5 kHz.

Understanding the directionality of pressure waves assists is early warning systems, such as in response systems, understanding natural events, or the like. Optionally, hydrophones receive pressure waves transmitted in aquatic environments and are a component of a system used to detect pressure waves. In examples using hydrophones, an array of hydrophones is used to gather and accumulate pressure waves. The accumulation of pressure waves, in some examples, is used to determine directionality of the source. In other examples, the accumulation of pressure waves is determined by a comparison of the representation of deflection of the first and second membranes

In aerial or terrestrial detection of pressure waves, microphones are optionally used. Microphones, in some examples, are similar to hydrophones. Microphones contains, for example, a diaphragm that vibrates in response to changes in pressure caused by sound waves. In examples, the diaphragm movement generates an electrical signal that is, optionally, amplified and processed. In some examples, microphones operate in an array to receive sufficient time delay between incoming pressure waves to determine directionality of the source of the pressure waves.

In some examples, vector sensors are used to detect directionality of the source of one or more pressure waves. Vector sensors, for example, capture acoustic particle velocity used to determine directionality while rejecting enhanced noise. In some instances, traditional vector sensors are mounted using mechanical components are susceptible to vibrational and flow-noise.

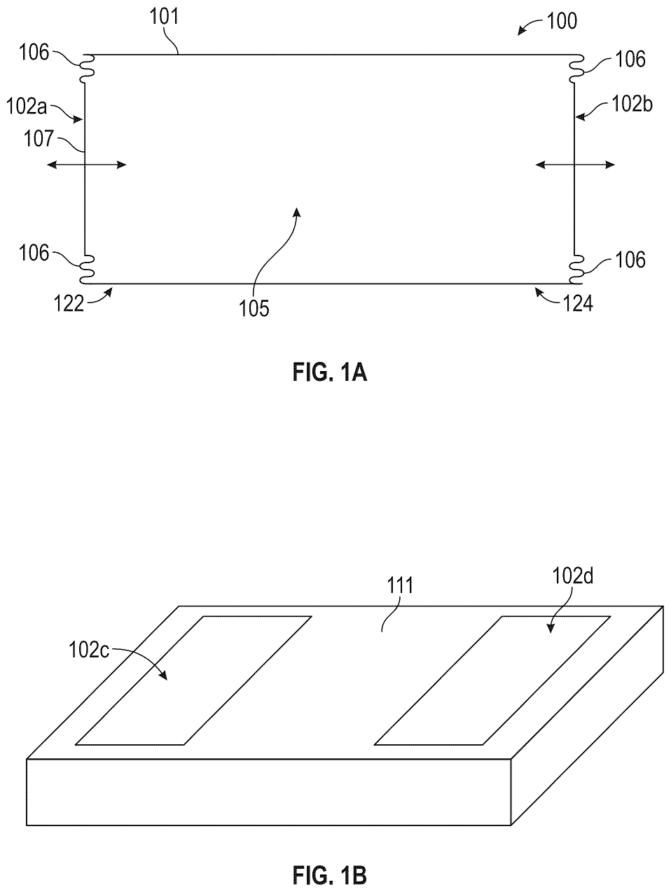

The present inventors have recognized that a problem to be solved includes using a singular device to measure components of pressure waves more accurately while minimizing size of the system. Illustrated in FIG. 1A is an example of a vector sensor 100. The vector sensor 100 includes, for example, a housing 101 defining a cavity 105. The cavity 105 optionally includes a fluid such as air or liquid. Optionally, the fluid is an oil, water or an aqueous solution. In some examples, the cavity includes an open-cell foam.

The vector sensor 100 includes, for example two or more membranes 102a, 102b (e.g., diaphragm or the like) coupled with the housing 101. For example, the vector sensor 100 includes a first membrane 102a and a second membrane 102b. In some examples, the first membrane 102a is coupled to a first end portion 122 of the housing 101 and the second membrane 102b is coupled to a second end portion 124 of the housing 101. In other examples, as illustrated in FIG. 1B, the first membrane 102c and the second membrane 102d are both coupled to the same side of a housing 111. In examples, as illustrated in FIG. 1B, the first membrane 102c is placed adjacent to the second membrane 102d. In other examples, the first membrane and the second membrane are arranged according to the specified purpose.

In examples, one or more membranes 102a, 102b are formed from a metal, ceramic or polymer. In some examples, the membrane includes piezoelectric characteristics. The material included in the one or more membranes 102a, 102b is, optionally, based on the designated purpose and the designated wavelength which the membrane responds to.

The two or more membranes 102a, 102b are at least partially deflectable (e.g., displaced, vibrated, undulated or the like). For example, one or more of the two or more membranes 102a, 102b has a rigid disk with a flexible rim. In another example, the one or more membranes 102a, 102b is a diaphragm with a flexible inner portion and stiff outer portion. In an example, the one or more membranes 102a, 102b is a diaphragm that is substantially inflexible such that areas of the one or more membranes (102) have minimal deflection as compared to other areas of the of the diaphragm. For instance, the first membrane 102a, 102c and the second membrane 102b, 102d have similar deflectable designs. In other instances, the first membrane 102a, 102c and the second membrane 102b, 102d have different deflectable designs.

In some examples, the first membrane 102a, 102c and the second membrane 102b, 102d have similar profiles where the first membrane 102a, 102c and the second membrane 102b, 102d has the same geometry. In other options, the first membrane 102a, 102c and the second membrane 102b, 102d have different profiles.

One or more membranes 102a, 102b are at least partially deflectable (e.g., displaced, vibrated, undulated or the like) in response to pressure waves. For example, one or more membranes 102a, 102b deflect when a pressure wave, such as very low frequencies (i.e., below 20 Hertz), low frequencies (i.e., between approximately 20 hertz to approximately 200 Hertz) and mid frequencies (i.e., between approximately 200 Hertz to approximately 2,000 Hertz) and high frequencies (i.e., between 2,000 Hertz to approximately 20,000 Hertz), contacts the respective membrane. In examples, the amount the membrane deflects is dependent according to the specified frequency to be measured, sensed or detected. In some examples, the amount of deflect is based on the mass of the membrane relative with the stiffness of the membrane. In some examples, the membrane spring damping influences the response or reception of the pressure wave.

Optionally, the one or more membranes 102a, 102b is coupled with the housing 101 with a deflection coupling 106. For instance, the deflection coupling 106 is a corrugation or a surrounding material that is different from the remaining portions of the membrane. Examples of a deflection coupling include springs, biasing members, or regions that are more elastic than a more inside region of the membrane. In examples, the deflection coupling 106 is different on different portions of the one or more membranes 102a, 102b. In examples, the deflection coupling 106 reciprocally deflects a diaphragm 107 of the membrane.

In some examples, one or more of the first membrane 102a, 102c and second membrane 102b, 102d are formed from Mylar, silicon or metal (e.g., stainless steel, aluminum or the like). Some examples of membranes 102a, 102b, 102c, 102d include the deflection coupling 106 that is formed from a flexible viscoelastic rubber or silicon. In some examples, damping is added to one or more of the first membrane 102a, 102c and second membrane 102b, 102d by way of perforate plate backplate positioned in close proximity for viscous damping. Or in other examples, damping layer might be added the membrane.

Optionally, the one or more membranes 102a, 102b is fluidly coupled. For example, a fluid such as oil, water or the like is disposed in the housing 101. The fluid that couples the one or more membrane transmits representations of the deflected (e.g., displaced, vibrated, undulated or the like) membrane from one membrane to the other. In examples, the fluid coupling transmits the representation of a deflection, or pressure wave, such that the deflection of the other membrane is less than the deflection of the membrane that primarily receives the pressure wave. Optionally, the magnitude of the primary membrane (e.g., the membrane that receives the pressure wave first) is less than another membrane.

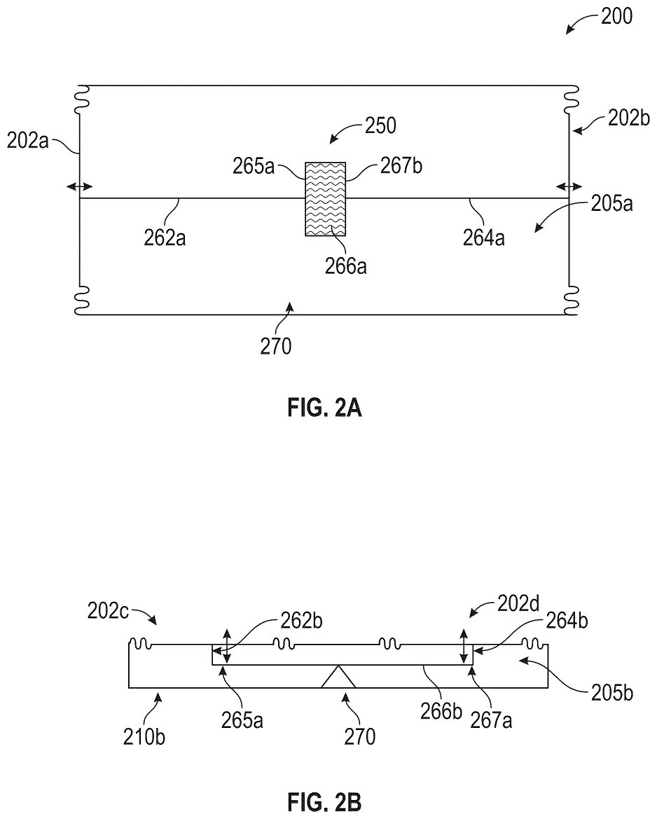

As illustrated in the example vector sensor 200 of FIGS. 2A and 2B, the first membrane 202a, 202c is coupled with the second membrane 202b, 202d with a coupling member 250. The coupling member 250 is, for example, a mechanical coupling or a fluid coupling. In example, the fluid coupling includes water (or aqueous solutions) or oil. In another example, the coupling member 250 includes at first linkage (e.g., strut, bar or the like) 262a joining, connecting or the like the first membrane 202a, 202c with an inner coupling 266a, 266b and a second linkage 264a, 264b joining, connecting or the like the second membrane 202b, 202d with the inner coupling 266a, 266b. In examples the inner coupling 266a, 266b is a deflection representative receiving coupling. In examples, the inner coupling 266a, 266b receives a representation, such as a reciprocal vibration, from the membrane through the coupling.

For instance, the first linkage 262a, 264a extends from the first membrane 202a, 202c to a first portion 265a of the of the inner coupling 266a, 266b and the second linkage 264a, 264b extends from the second membrane 202b, 202d to a second portion 267a, 267b of the inner coupling 266a, 266b. In an example, the first linkage 262a, 264b and the second linkage 264a, 264b have a stiffness greater than the inner coupling 266a, 266b. Optionally, the inner coupling 266a, 266b is less stiff than the first linkage 262a, 262b and the second linkage 264a, 264b.

As illustrated in FIG. 2A, the first linkage 262a extends longitudinally within the cavity 205a from the first membrane 202a to a first portion 265a of the inner coupling 266a. The inner coupling 266a is optionally centrally located within the cavity 205a between the first membrane 202a and the second membrane 202b. For example, the inner coupling 266a receives a representation of deflection transmitted through the first linkage 262a or the second linkage 264a. The representation of deflection is, for example, the mechanical response to the pressure wave such as a deflection (e.g., vibration, undulation or the like) of the membrane. This representation of deflection is, for example, transmitted through the linkage to the inner coupling 266a. In another option, the inner coupling 266a is located closer to one of the first membrane 202a or the second membrane 202b. The inner coupling 266a, as illustrated in FIG. 2A, is a viscoelastic foam or a spring disposed longitudinally between the first linkage 262a and the second linkage 264a.

As illustrated in FIG. 2B, a first membrane 202c and a second membrane 202d are located on the same side of a housing 210b. For instance, the first membrane 202c and the second membrane 202d are longitudinally spaced from each other on the same side of the housing 210b. In an example, a first linkage 262b extends inwardly within a cavity 205b and a second linkage 264b extends inwardly within the cavity 205b. For example, the first linkage 262b and the second linkage 264b are longitudinally spaced within the cavity 205b. For example, the first linkage 262b extends inwardly within the cavity 205b from the first membrane 202c and the second linkage 264b extends inwardly within the cavity 205b from the second membrane 202b.

In an example, a flexible inner coupling 266b is connected to one or more of the first membrane 202c and the second membrane 202d. One or more of the first linkage 262b and the second linkage 264b are stiff coupling having a higher stiffness than the flexible inner coupling 266b. In an example the flexible inner coupling 266b is a flexible bar or beam. Optionally, the flexible coupling 266b is optionally a spring-like member.

As illustrated in FIG. 2A and FIG. 2B, the first membrane 202a and the second membrane 202b are coupled through the inner coupling 266a, 266b forming a coupled system 270. The coupled system 270, hereinafter, refers to both the inner coupling 266a, 266b connected with the first linkage 262a, 262b and the second linkage 264a, 264b. When the first linkage 262a, 262b and the second linkage 264a, 264b are coupled, a representation of deflection is transmitted through the coupling. The representation of deflection is, for example, the mechanical response to the pressure wave such as a deflection (e.g., vibration, undulation or the like) of the membrane. In an example, the representation of deflection is accumulated as the relative deflection. The relative deflection is optionally transmitted to a sensor that communicates the accumulated response to a processor or control system.

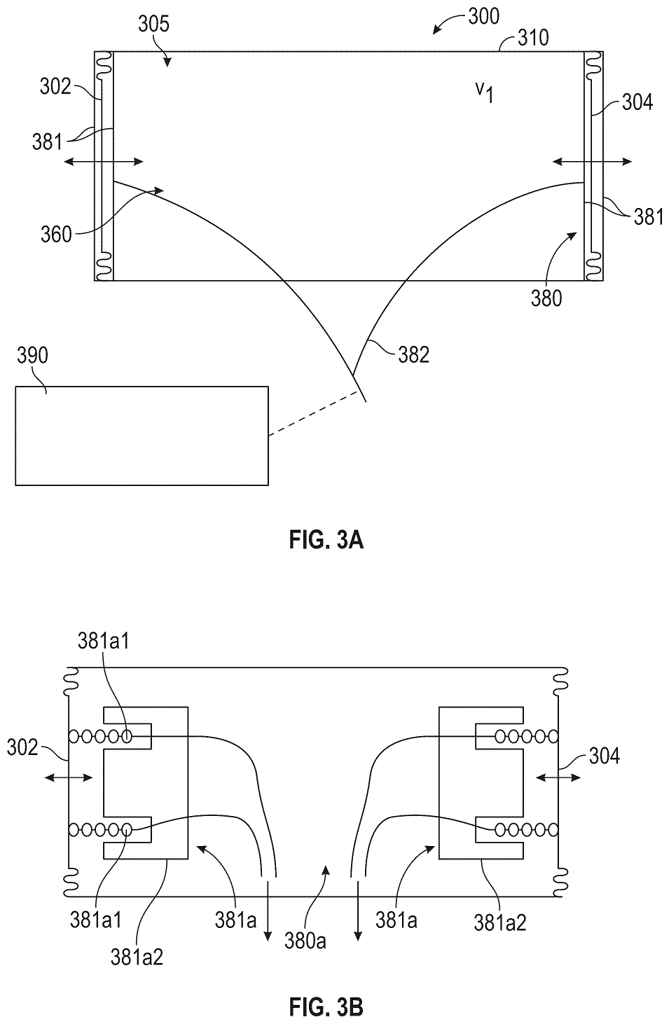

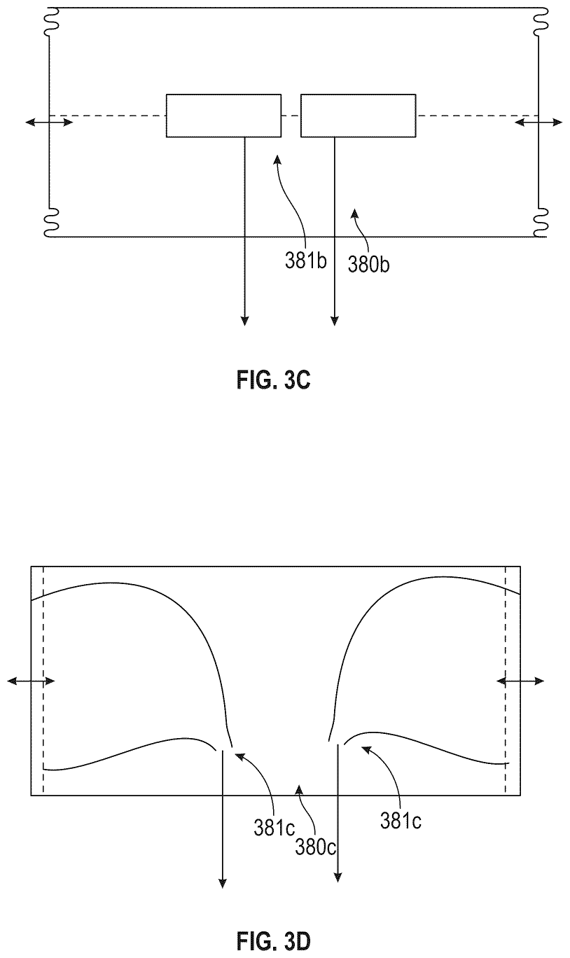

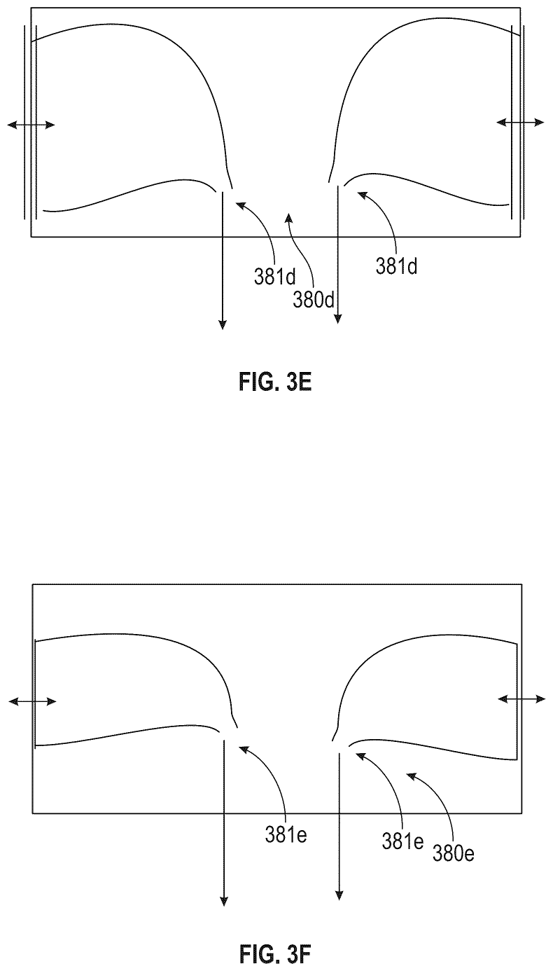

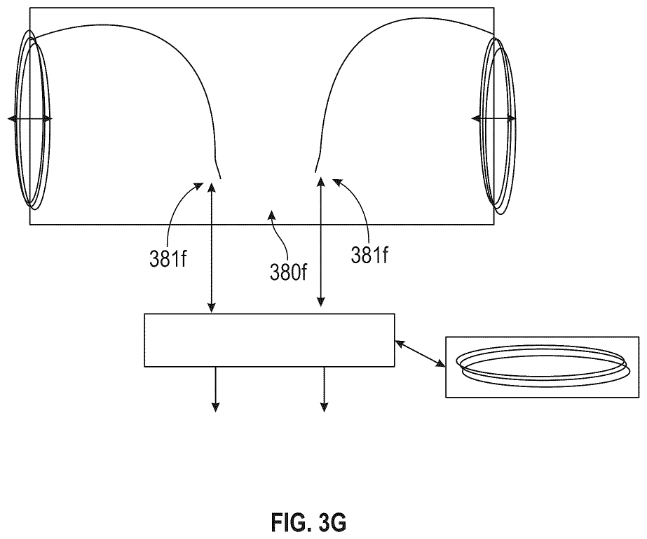

In an example illustrated in one or more of FIGS. 3A-F there are several different internal sensing system 380 options that can be used to receive, monitor or detect the sensed deflection (e.g., displacement, vibration, undulation or the like) of the first membrane 302 or second membrane 304. In an example, the relative deflection received by the internal sensing system includes a difference between the magnitude, amplitude or time difference between the first membrane 302 and second membranes 304. The internal sensing system 380 receives indications of inward or outward deflection of one or more of the membranes 302, 304 (e.g., representation of deflection). The membranes deflection is based on, for example, a received pressure wave, such as an acoustic wave. The first membrane 302 and the second membrane 304 are optionally coupled with an internal volume coupling 360. In an example, the internal volume coupling 360 includes a coupling fluid contained within a cavity 305 of the housing 310. The fluid is, for example, water, oil or an electro-fluid.

The coupling fluid, optionally, provides a stiff coupling between the first membrane 302 and the second membrane 304. The coupling fluid as a stiff coupling provides a coupled, or accumulated, membrane deflection. The first membrane 302 and the second membrane 304 are connected through the cavity 305. The response from the first membrane 302 and second membrane 304 is a coupled response that is, for example, communicated through the wiring internal sensor system 380 to the processor 390.

The mechanical coupling 266a, 266b, as illustrated in FIGS. 2A and 2B, extending within the cavity 305 of the housing 310 is another option for transmitting the deflection of the first membrane 302 and second membrane 304 to the internal sensor system 380. In an example, the response from the first membrane 302 and the second membrane 304 are connected through one or more of the first linkage 262a, 262b or second linkage 264a, 264b and the inner coupling 266a, 266b. Similar to the coupling fluid as a stiff fluid, the inner coupling 266 provides a coupled, or accumulated, membrane deflection.

Illustrated in FIG. 3A is an optional arrangement of an internal sensor system 380. The internal sensor system 380 is optionally connecting to one or more receptors 381. The one or more receptors 381 are in communication with one or more of the first membrane 302 or the second membrane 304. The one or more receptors 381 are placed proximate to the first membrane 302 or second membrane 304, respectively, such that the one or more receptors 381 detects or monitors the amount of deflection of the first membrane 302 or second membrane 304, respectively. In some examples, the one or more receptors 381 is internal of the housing 310. In other examples, the one or more receptors 381 is located external of the housing 310 and the first membrane 302 or second membrane 304, respectively. In another example, the one or more receptors 381 is located both internally and externally to receive both inward (towards the interior of the housing) deflection of the first membrane 302 and second membrane 304 and outward (towards the environment or exterior of the housing) deflection of the first membrane 302 and second membrane 304.

In examples, the internal sensor system 380 includes wiring 382 or other transmitting devices connected with one or more one or more receptors 381 or directly with the first membrane 302 or second membrane 304 to transmits indications of deflection from the vector sensor 300 to a processor 390 (e.g., control unit, computer or the like). Optionally, the respective deflection of one or more of the first membrane 302 and the second membrane 304 is transmitted to the processor 390 and the accumulation of the sensed deflection is processed by the processor.

Illustrated in FIG. 3B is one example of an internal sensor system 380a including a one or more receptors 381 as an electromagnetic sensor 381a. The electromagnetic sensing 381a includes one or more electromagnetic coils 381al (e.g., springs, bias members, or the like) and associated magnets 381a2 in communication with one or more of the first membrane 302 or second membrane 304. Internal of the housing 310 is optionally a coupling fluid, as previously discussed above and related to FIG. 1A, 1B or 3A. As the coils 381al are moved from one or more of the first membrane 302 or second membrane 304 the electromagnetic sensor 381a transmits the amount of movement of the coils 381a1 through to a processor (e.g., control unit, computer or the like). The coupled response from the internal sensor system 380a is coupled resulting in a directionality indication.

Illustrated in FIG. 3C is one example of an internal sensor system 380b including one or more receptors 381 as an optical or laser sensor 381b. The optical or laser sensor 381b includes one or more fiber optic or laser interferometer probes, or the like. As the first membrane 302 and the second membrane 304 deflect towards the interior or exterior of the housing 310 in response to a pressure wave, the optical or laser sensor 381b optionally senses, detects or communicates the deflection of the first membrane 302 or the second membrane 304. The optical or laser sensor 381b optionally transmits the sensed or monitored or response or detection or the like to the processor 390 (as illustrated in FIG. 3A).

As the first membrane 302 and the second membrane 304 deflect towards the interior or exterior of the housing 310 in response to a pressure wave, the optical or laser sensor 381b optionally senses, detects or communicates the deflection of the first membrane 302 or the second membrane 304. The optical or laser sensor 381b optionally transmits the sensed or monitored or response or detection or the like to the processor 390 (as illustrated in FIG. 3A).

Illustrated in FIG. 3D is one example of an internal sensor system 380c including one or more receptors 381 as capacitive sensor 381c. The capacitive sensor 381c emits an electrical field from a sensing end of the sensor. Any target that can disrupt this field can be detected by the capacitive sensor 381c, such as the membrane first membrane 302 or second membrane 304. The capacitive sensor 381c has a sensing face oriented towards one or more of the first membrane 302 or second membrane 304. In an example, the first membrane 302 or second membrane 304 is an electrically charged membrane such as a metal. In examples, the metal is stainless steel, aluminum or the like. The capacitive sensor 381c is optionally coupled with a wire or other features that send signals representative of the sensed or monitored or response or detection from the capacitive sensor 381c to the processor 390 (as illustrated in FIG. 3A).

Illustrated in FIG. 3E is one example of an internal sensor system 380d including one or more receptors 381 as a piezoelectric sensor 381d. The piezoelectric sensor 381d includes one or more electrode layers 381d1 arranged proximate to one or more of the first membrane 302 or second membrane 304. In an example, one or more of the first membrane 302 or second membrane 304 is a piezoelectric membrane. For example, the first membrane 302 or second membrane 304 is formed from a ceramic, piezoelectric polymer or the like. As the first membrane 302 and the second membrane 304 deflect towards the interior or exterior of the housing 310 in response to a pressure wave, the piezoelectric sensor 381d optionally senses, detects or communicates the deflection of the first membrane 302 or the second membrane 304. The piezoelectric sensor 381d optionally transmits the sensed or monitored or response or detection or the like to the processor 390 (as illustrated in FIG. 3A).

Illustrated in FIG. 3F is one example of an internal sensor system 380e including one or more receptors 381 as a piezoresistive sensor 381e. The piezoresistive sensor 381e includes one or more piezoelectric resisters 381e1 arranged proximate to one or more of the first membrane 302 or second membrane 304. In an example, one or more of the first membrane 302 or second membrane 304 is a piezoelectric membrane. For example, the first membrane 302 or second membrane 304 is formed from a ceramic, piezoelectric polymer or the like. As the first membrane 302 and the second membrane 304 deflect towards the interior or exterior of the housing 310 in response to a pressure wave, the piezoresistive sensor 381e optionally senses, detects or communicates the deflection of the first membrane 302 or the second membrane 304. The piezoresistive sensor 381e optionally transmits the sensed or monitored or response or detection or the like to the processor 390 (as illustrated in FIG. 3A).

Illustrated in FIG. 3G is one example of an internal sensor system 380f including one or more receptors 381 as a fiber optic sensor 381f. The fiber optic sensor 381f includes one or more fiber optic coils 381f1 arranged proximate to one or more of the first membrane 302 or second membrane 304. In an example, one or more of the first membrane 302 or second membrane 304 is a membrane formed from metal or the like. As the first membrane 302 and the second membrane 304 deflect towards the interior or exterior of the housing 310 in response to a pressure wave, the fiber optic coils 381f1 optionally senses, detects or communicates the deflection of the first membrane 302 or the second membrane 304. One or more of the fiber optic coils 381f1 are optionally in communication with a fiber optic integrator 381f2. For example, the fiber optic integrator 381f2 is in communication with a fiber optic coil references 381f3. The fiber optic sensor 381f optionally transmits the sensed or monitored or response or detection or the like to the processor 390 (as illustrated in FIG. 3A).

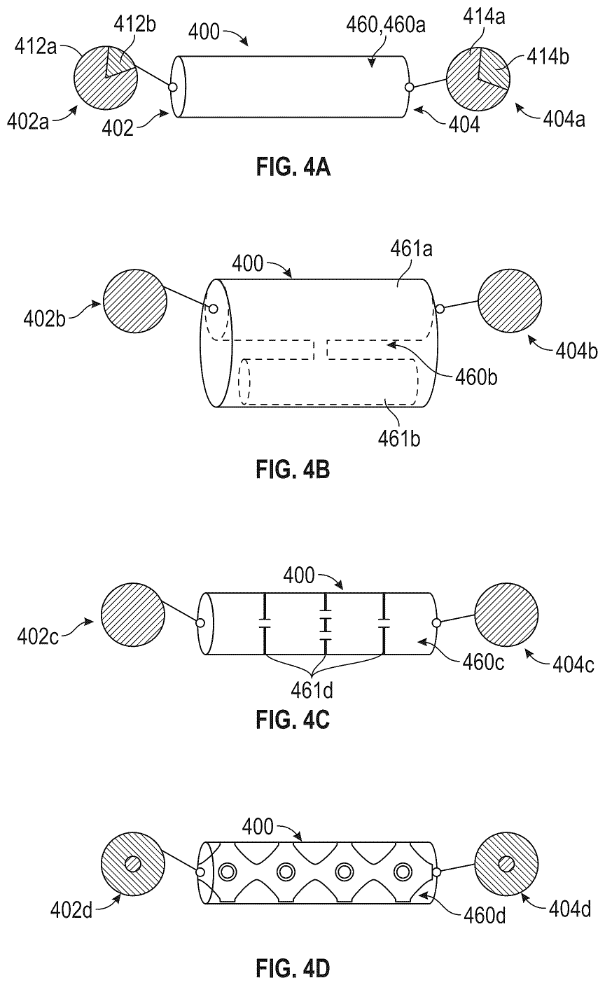

Illustrated in FIGS. 4A-4D are optional arrangements of internal volume coupling 460 arrangements within vector sensors 400. The vector sensors 400 illustrated in FIGS. 4A-4D have at least a first membrane 402 and a second membrane 404.

The internal volume coupling 460a in FIG. 4A is optionally similar to the internal coupling volume discussed related to FIG. 1A, 1B or 3A. Optionally, the first membrane 402a includes a flexible region 412a and a rigid region 412b. For example, the rigid region 412b is less flexible than the flexible region 412a such that the flexible region 412a deflects more than the rigid region 412b in response to pressure waves.

In another example, the second membrane 404a includes a second membrane flexible region 414a and a second membrane rigid region 414b. Optionally, the second membrane flexible region 414a and the second membrane rigid region 414b occupy a different amount of the second membrane 404a than the first membrane 402a. For example, the second membrane 404a flexible region 414a occupies a greater amount of the second membrane 404a than the second membrane 404a second membrane rigid region 414b.

In another example illustrated in FIG. 4B is another configuration of the internal volume coupling 460. The internal volume 460b is, for example, partitioned into two or more internal volume couplings. The internal volume 460b is optionally partitioned into a first volume coupling 461a and a second volume 461b. In an example, the first volume coupling 461a is in communication with the second volume 461b. Partitioning the internal volume couplings optionally provides a stiffer internal volume coupling. In examples, partitioning the internal volume can form additional frequency-dependent coupling responses between membranes 402 and 404 that allow for tuning the system response to a desired frequency range.

Optionally, a first membrane 402b is coupled with one portion of the first volume coupling 461a and a second membrane 404b is coupled with an opposing portion of the first volume coupling 461a. Deflections (e.g., displacements, vibrations, undulations or the like) received by the 402b and the 404b are, for example accumulated and detected or sensed by a sensor, such as those discussed related to FIGS. 3A-3G. In an example, one or more of the first membrane 402b and the second membrane 404b are flexible membranes such that each region of the first membrane 402b and the second membrane 404b are similarly flexible across the first membrane 402b and the second membrane 404b.

In another example, as illustrated in FIG. 4C is another configuration of the internal volume coupling 460. The internal volume coupling 460c is partitioned with one or more partitioning walls 461c. The one or more partitioning walls 461c optionally include openings allowing for communication between partitioned areas and optionally allowing for the deflection of one of first membrane 402c or second membrane 404c to be accumulated with the other of the first membrane 402c or the second membrane 404c. The first membrane 402c and the second membrane 404c are optionally similarly flexible across the first membrane 402c and the second membrane 404c.

In another example, as illustrated in FIG. 4D is another configuration of the internal volume coupling 460. The internal volume 460d is partitioned with one or more membranes 461d. In an example, the one or more membranes 461d is be a wall, such as a rigid structure, that connects the different fluid regions through perforations in the wall. The one or more internal membranes 461d optionally include openings allowing for communication between partitioned areas and optionally allowing for the deflection of one of first membrane 402d or second membrane 404d to be accumulated with the other of the first membrane 402d or the second membrane 404d. In an example, the deflection of each of the one or more internal membranes 461d is accumulated, detected or sensed. Optionally, the deflection of the one or more internal membranes 461d is accumulated with the deflection of the first membrane 402d or the second membrane 404d.

In an example, each of the first membrane 402d and the second membrane 404d include a flexible region 412a, 414a and a rigid region 412b, 414b. Optionally, the flexible region 412a, 414a and the rigid region 412b, 414b are similar with each of the one or more internal membranes 461d.

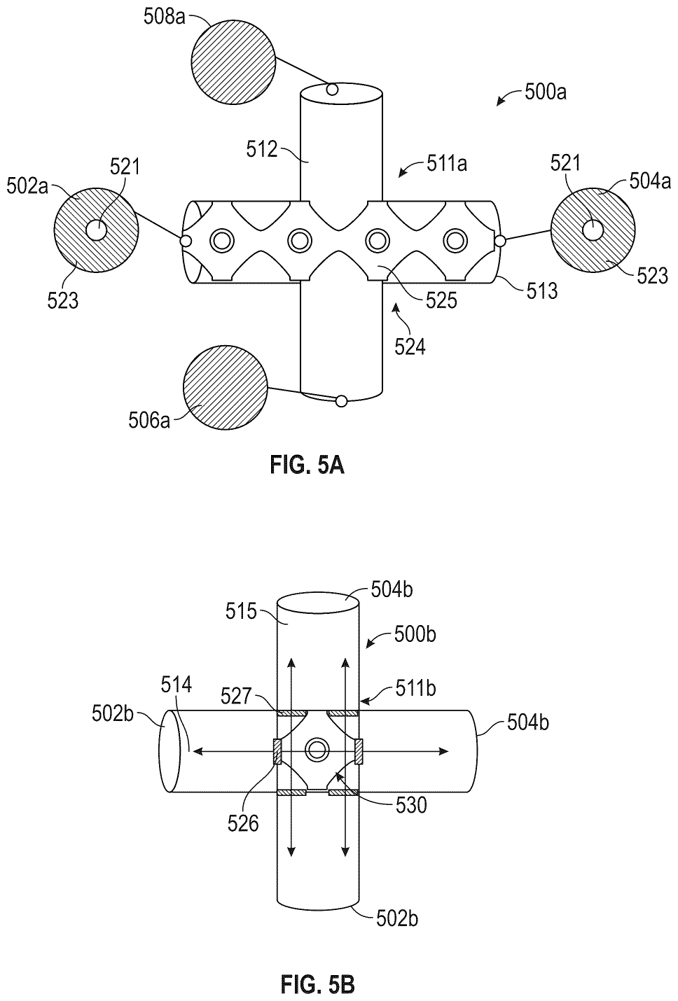

Illustrated in FIGS. 5A and 5B are optionally arrangement of vector sensors 500a and 500b. The vector sensors 500a and 500b are, for instance, similar to the vector sensors previously discussed, such that the housing 511a, 511b include a coupling and membranes. In some examples, the coupling is a fluid coupling. In other examples, the coupling is a strut or stiff linkage coupling. The type of coupling in the vector sensor is determined on the function and use of the vector sensor.

In the example vector sensors 500a the housing 511a includes two or more interconnected channels 512, 513. A first membrane 502a of the first channel 512 is, for example, positioned on an opposed side of the channel 512 from a second membrane 504a and a third membrane 506a is positioned on an opposed side from a fourth membrane 508a. In some examples, the first membrane 502a and the second membrane 504a are similar membranes. For example, the first membrane 502a and the second membrane 504a have flexible regions 521 and rigid regions 523 (e.g., regions that are less flexible than a flexible region). Optionally, the third membrane 506a and the fourth membrane 508a are different membranes from the first membrane 502a and the second membrane 504a. In an example, the third membrane 506a and the fourth membrane 508a are formed from a material that is flexible across the membrane.

In some examples, at least a portion of a first channel 512 intersects with a second channel 513. The intersection 524 of the first channel 512 and the second channel 513 is, for example, a location within the housing 511a where the pressure wave response from the first membrane 502a, the second membrane 504a, the third membrane 506a and the fourth membrane 508a is accumulated or collected.

Optionally, one of the first channel 512 and the second channel 513 includes one or more internal membranes 525. The one or more internal membranes 525 optionally are an array or chain of membranes that interconnect the associated membrane, in this example the first membrane 502a with the second membrane 504a.

Illustrated in FIG. 5B is another vector sensor 500b including the housing 511b. The housing 511b includes an integrated sensor with a first sensor element 514 and a second sensor element 515. In some examples, the first sensor element 514 is a different type of sensor than the second sensor element 515. In other instances, the first sensor element 514 and the 515 are the same type of sensor. The first sensor element 514 and the second sensor element 515 each have a first membrane 502b and a second membrane 504b. The first membrane 502b is on an opposed side of the sensor element from the second membrane 504b.

At an intersection of the first sensor element 514 and the second sensor element 515 is optionally, an internal coupling 530. The internal coupling 530 optionally includes one or more first internal membranes 526 and a second internal membrane 527. The first internal membrane 526, in some examples is positioned relative to an opening of the one or more internal membranes 526. The second internal membrane 527 is positioned around or on a proximate to a perimeter of the one or more internal membranes 525. In an example the first internal membrane 526 is associated with the first sensor element 514 and the second internal membrane 527 is associated with the second sensor element 515.

The vector sensors illustrated in 5A and 5B are examples of sensors that, for example, are able to detect the direction from where a pressure wave is originating according to an accumulation of datapoints. The datapoints, for example, are the responses to the deflection of one or more of the membranes. In some instances, the accumulation of the responses provides a more accurate location of the origin of the pressure wave.

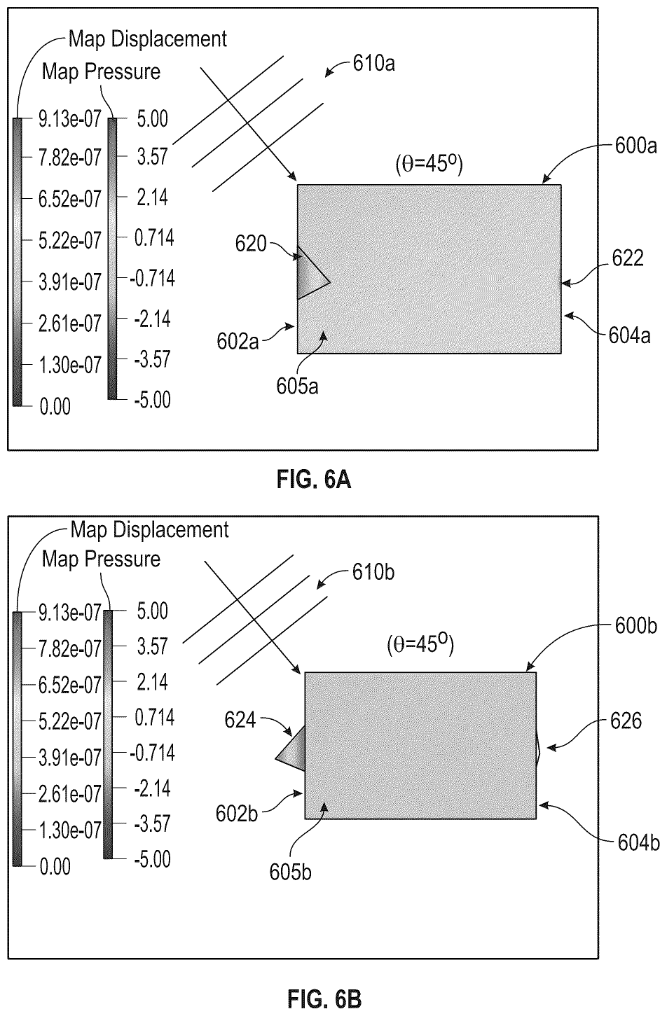

Illustrated in FIGS. 6A and 6B are exaggerated graphical examples of a measured deflection of one or more of the membranes, as previously described. FIGS. 6A and 6B are also representations of two different snapshots in time of the membrane responses as the pressure wave travels through the coupling. In the examples illustrated there is a phase delay and amplitude difference between the left and right membrane deflections (e.g., vibrations, deformation or the like) as a function of the angle which the pressure wave contacts the left or right membrane. For example, as illustrated in FIG. 6A, an angle of a pressure wave 610a is approximately 45 degrees. Since the angle of the pressure wave 610a is 45 degrees and proximate to the left side of the vector sensor 600a, the amount of the deflection 620 of a left membrane 602a is a greater degree of deflection towards the interior of the cavity 605a than the amount of deflection 622 of a right membrane 604a.

In examples, the cavity 605a includes one or more of a fluid coupling or a strut or stiff linkage coupling. The internal coupling, for example a fluid coupling, assists in providing an asymmetric membrane response to an incident pressure field. For example, when the left membrane 602a and the right membrane 604a are coupled, the measurement of the deflection is, for example, a larger difference in the amount of deflection than in situations where the membranes are not coupled with a stiff coupling, either fluid or strut. In examples where a coupling, either fluid or mechanical, is not used the response of the left and right membrane is similar. Where in situations where the left and right membranes are coupled, the magnitude of the deflection has a greater difference.

In examples with a fluid coupling, as one of the left membrane 602a or right membrane 604a is deflection is transmitted through the fluid toward the other of the left membrane 602a and right membrane 604a and suppresses the reciprocal response from the opposing membrane.

As illustrated in FIG. 6B, for example, the angle of the pressure wave 610b is approximately 45 degrees. Since the angle of the pressure wave 610b is 45 degrees and proximate to the left side of the vector sensor 600b, the amount of the deflection 624 of a left membrane 602b is a greater degree of deflection towards the exterior of the cavity 605b than the amount of deflection 626 of a right membrane 604b. In examples, the deflection 624 of the left membrane 602b and the deflection 626 of the right membrane 604b is a reciprocal deflection as related to the interior deflection.

In some examples, a coupling spring stiffness, such as the coupling fluid, between the right membrane and the left membrane affects the frequency and the amount of deflection (e.g., magnitude of deflection) and the time delay of the response. In example membranes, there is an optimum or approximately optimum stiffness coefficient that maximizes the directional sensitivity of the vector sensor. The optimum or approximately optimum stiffness of the system, at times, affects the sensitivity of the sensor as related to a specific range of pressure sensor responses.

In examples, a detectable membrane response, or a deflection of the membrane a specified amount, varies as a function of an incident sound angle. This difference in magnitude and time delay between at least two membranes results in a true vector sensor.

In some examples, the pressure wave is detected and measured through an array or series of membranes. For instance, more membranes within a cavity provides better performance as related to measurement of the differences in deflection (e.g., magnitude of deflection) according to a measured time delay. In examples, including multiple membranes achieves better performance over a larger frequency range.

In some examples, the representation of a pressure wave is transmitted through the coupling, fluid or mechanical, from a one or more of the deflected first membrane or deflected second membrane to an inner coupling member or to another membrane. The representation of the pressure wave is optionally transmitted from one or the coupling member or membranes to the sensor. The sensor, in some examples, transfers the received representation of the pressure wave to a process. In other examples, the sensor measure sensed values or representations of the pressure wave, where the sensed values or representations of the pressure wave include, but are not limited to amplitude, magnitude or phase of the pressure wave.

The sensed information is optionally transmitted to a processor or control system to be compiled, accumulated or the like. The compiled or accumulated information is representative of a directionality of a pressure wave.

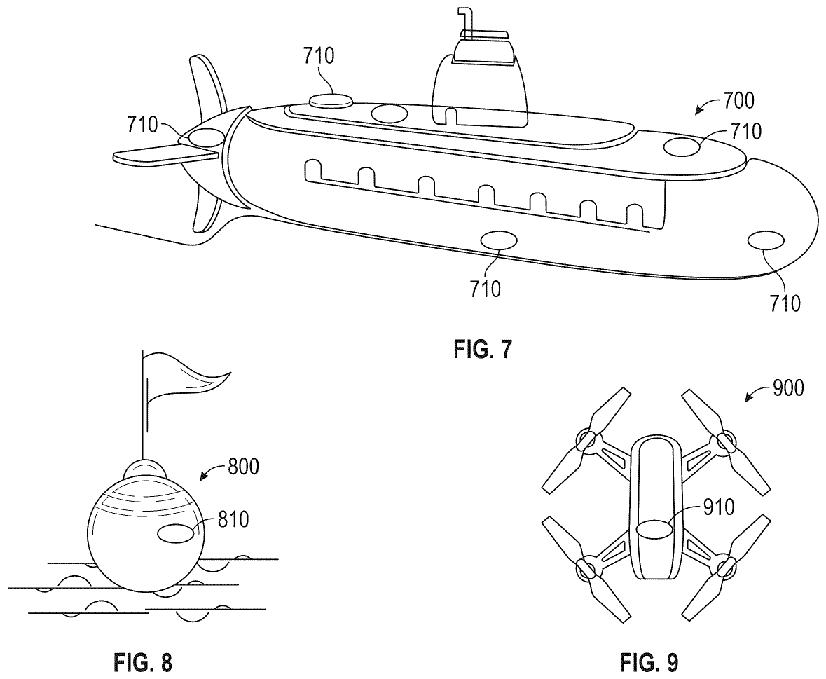

In some examples, one or more vector sensors is coupled to a ground system, an aquatic system or aeronautic system. For example, as illustrated in FIG. 7, one or more vector sensors 710 are coupled at one or more locations on a submersible vehicle 700 as a component of a sonar system. In other examples, as illustrated in FIG. 8, one or more vector sensors 810 are a component of a sonar system coupled with a buoy 800, submerged or floating, or the like. In another example, as illustrated in FIG. 9, the one or more vector sensors 910 is a component coupled with a drone 900 or other aeronautic system.

### VARIOUS NOTES AND ASPECTS

Aspect 1 can include a vector sensor comprising: a housing defining a cavity extending through the housing; a first sensing membrane connected with the housing, the first membrane including: a first deflectable surface configured to deflect in response to a pressure wave; a second sensing membrane spaced from the first membrane and connected with the housing, the second membrane including: a second deflectable surface configured to deflect in response to the pressure wave; a coupling positioned between the first membrane and the second membrane, the coupling in communication with the first membrane with the second membrane; and a sensor in communication with one or more of the first membrane, the second membrane or the coupling; wherein the sensor is configured monitor a representation of deflection of one or more of the first membrane and second membrane.

Aspect 2 can include, or can optionally be combined with the subject matter of Aspect 1, to optionally include the coupling including a fluid housed within the cavity configured to couple a deflection of the first membrane with a deflection of the second membrane.

Aspect 3 can include, or can optionally be combined with the subject matter of Aspect 1 or 2, to optionally include the coupling including a first strut extending between the first membrane and a deflection representative receiving coupling; and a second strut extending between the second membrane and the coupling.

Aspect 4 can include, or can optionally be combined with the subject matter of Aspect 1 to 3, to optionally include the representation of deflection includes a composite deflection including a deflection of the first membrane and a deflection of the second membrane.

Aspect 5 can include, or can optionally be combined with the subject matter of Aspect 1 to 4, to optionally include the coupling is configured to transfer the representation of deflection of one or more of the first membrane or the second membrane to the sensor.

Aspect 6 can include, or can optionally be combined with the subject matter of Aspect 1 to 5, to optionally include the first membrane is connected with one end of the housing and the second membrane is connected with an opposing end of the membrane.

Aspect 7 can include, or can optionally be combined with the subject matter of Aspect 1 to 6, to optionally include the first membrane and the second membrane are positioned on a same side of the housing.

Aspect 8 can include, or can optionally be combined with the subject matter of Aspect 1 to 7, to optionally include the sensor is one or more of an electromagnetic, optical, capacitive, piezoelectric, piezoresistive, or fiber optic sensor.

Aspect 9 can include, or can optionally be combined with the subject matter of Aspect 1 to 8, to optionally include the housing includes: a first channel and a second channel, the second channel intersecting the first channel; wherein the second channel includes a second channel first end portion including membrane and a second channel second end portion; wherein the second channel first end portion includes a third membrane and the second channel second end portion includes a fourth membrane; and one or more inner membranes positioned within the intersection of the first channel and the second channel.

Aspect 10 can include an acoustic system comprising: a processor; a control unit included in the processor; and a vector sensor including: a housing defining one or more channels, each of the one or more channels including a first end portion and a second end portion; a first membrane connected to the housing at the first end portion including: a first outer region connected to the housing more elastic than a second inner region; a second membrane connected to the housing at the second end portion including: a second outer region connected to the housing more elastic than a second inner region; a coupling positioned within the channel, the coupling connecting the first membrane with the second membrane; and a sensor in communication with one or more of the first membrane, the second membrane or the coupling.

Aspect 11 can include, or can optionally be combined with the subject matter of Aspect 10, to optionally include including one or more membranes positioned within the channel.

Aspect 12 can include, or can optionally be combined with the subject matter of Aspect 10 or 11, to optionally include the coupling is configured to transmit a representation of deflection of one or more of the first membrane or second membrane to the other of the first membrane or the second membrane.

Aspect 13 can include, or can optionally be combined with the subject matter of Aspect 10 to 12, to optionally include the coupling includes a first strut extending from the first membrane to an inner coupling and a second strut extending from the second membrane to the inner coupling; wherein the inner coupling includes a foam.

Aspect 14 can include, or can optionally be combined with the subject matter of Aspect 10 to 13, to optionally include the first membrane is positioned adjacent to the second membrane on one side of the housing; wherein a first linkage extends from the first membrane into the channel and a second linkage extends from the second membrane into the channel; wherein a flexible inner coupling connects the first linkage to the second linkage.

Aspect 15 can include, or can optionally be combined with the subject matter of Aspect 10 to 14, to optionally include the sensor is configured to detect a magnitude of a representation of deflection of one or more of the first membrane or the second membrane; wherein the sensor is configured transmits the representation of deflection to the processor.

Aspect 16 can include, or can optionally be combined with the subject matter of Aspect 10 to 15, to optionally include comprising one or more of a submersible, a ground vehicle or an air vehicle having each of the processor, control unit and the vector sensor.

Aspect 17 can include, a method of detecting a directionality of a pressure wave, including but not limited to a sonic, subsonic or supersonic waves, the method including: receiving the pressure wave with a vector sensor, the vector sensor including: a housing including a channel; a first membrane and second membrane positioned on the housing; a coupling member within the channel connecting the first membrane and the second membrane; and a sensor connected to one or more of the first membrane, the second membrane or the coupling member; the pressure wave deflecting one or more of the first membrane or the second membrane; transmitting a representation of the pressure wave from one or more of the deflected first membrane or deflected second membrane through the coupling member; transferring the representation of the pressure wave from the coupling member to the sensor; and measuring sensed representation of deflection from the sensor; wherein the sensed representations of deflection are representative one of amplitude, magnitude, or phase of the pressure wave.

Aspect 18 can include, or can optionally be combined with the subject matter of Aspect 17 to optionally include the sensor measures a displacement of one or more of the first membrane or the second membrane.

Aspect 19 can include, or can optionally be combined with the subject matter of Aspect 17 or 18, to optionally include the vector sensor includes one or more membranes disposed within the channel; wherein the one or more membranes transmits a representation of the pressure wave to an adjacent membrane.

Aspect 20 can include, or can optionally be combined with the subject matter of Aspect 17 to 19, to optionally include the coupling is one or more of a fluid coupling or a mechanical coupling.

Each of these non-limiting aspects can stand on its own, or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A vector sensor comprising:
a housing defining a cavity extending through the housing;
a first sensing membrane connected with the housing, the first membrane including:
a first deflectable surface configured to deflect in response to a pressure wave;
a second sensing membrane spaced from the first membrane and connected with the housing, the second membrane including:
a second deflectable surface configured to deflect in response to the pressure wave;
a coupling positioned between the first membrane and the second membrane, the coupling in communication with the first membrane with the second membrane; and
a sensor in communication with one or more of the first membrane, the second membrane or the coupling;
wherein the sensor is configured to monitor a representation of deflection of one or more of the first membrane and second membrane.

2. The vector sensor of claim 1, wherein the coupling includes a fluid housed within the cavity configured to couple a deflection of the first membrane with a deflection of the second membrane.

3. The vector sensor of claim 1, wherein the coupling includes:
a first strut extending between the first membrane and a deflection representative receiving coupling; and
a second strut extending between the second membrane and the coupling.

4. The vector sensor of claim 1, wherein the representation of deflection includes a composite deflection including a deflection of the first membrane and a deflection of the second membrane.

5. The vector sensor of claim 1, wherein the coupling is configured to transfer the representation of deflection of one or more of the first membrane or the second membrane to the sensor.

6. The vector sensor of claim 1, wherein the first membrane is connected with one end of the housing and the second membrane is connected with an opposing end of the membrane.

7. The vector sensor of claim 1, wherein the first membrane and the second membrane are positioned on a same side of the housing.

8. The vector sensor of claim 1, wherein the sensor is one or more of an electromagnetic, optical, capacitive, piezoelectric, piezoresistive, or fiber optic sensor.

9. The vector sensor of claim 1, wherein the housing includes:
a first channel and a second channel, the second channel intersecting the first channel;
wherein the second channel includes a second channel first end portion including membrane and a second channel second end portion;
wherein the second channel first end portion includes a third membrane and the second channel second end portion includes a fourth membrane; and
one or more inner membranes positioned within the intersection of the first channel and the second channel.

10. An acoustic system comprising:
a processor;
a control unit included in the processor; and
a vector sensor including:
a housing defining one or more channels, each of the one or more channels including a first end portion and a second end portion;
a first membrane connected to the housing at the first end portion;
a second membrane connected to the housing at the second end portion;
wherein the first and second membranes are interconnected by the one or more channels;
a coupling positioned within the channel, the coupling connecting the first membrane with the second membrane; and
a sensor configured to detect a relative deflection between the first and second membranes.

11. The acoustic system of claim 10, including one or more membranes positioned within the channel.

12. The acoustic system of claim 10, wherein the coupling is configured to transmit a representation of deflection of one or more of the first membrane or second membrane to the other of the first membrane or the second membrane.

13. The acoustic system of claim 10, wherein the coupling includes a first strut extending from the first membrane to an inner coupling and a second strut extending from the second membrane to the inner coupling;
wherein the inner coupling includes a foam.

14. The acoustic system of claim 10, wherein the first membrane is positioned adjacent to the second membrane on one side of the housing;
wherein a first linkage extends from the first membrane into the channel and a second linkage extends from the second membrane into the channel;
wherein a flexible inner coupling connects the first linkage to the second linkage.

15. The acoustic system of claim 10, wherein the sensor is in communication with one or more of the first membrane, the second membrane or the coupling and configured to detect a magnitude of a representation of deflection of one or more of the first membrane or the second membrane;
wherein the sensor is configured to transmit the representation of deflection to the processor.

16. The acoustic system of claim 10, comprising one or more of a submersible, a ground vehicle or an air vehicle having each of the processor, control unit and the vector sensor.

17. A method of detecting a directionality of a pressure wave, the method comprising:
receiving the pressure wave with a vector sensor, the vector sensor including:
a first membrane and second membrane interconnected with a channel;
a coupling member within the channel connecting the first membrane and the second membrane; and
a sensor configured to detect a relative deflection between the first and second membranes
deflecting one or more of the first membrane or the second membrane with the pressure wave;
transmitting a representation of the pressure wave from one or more of the deflected first membrane or deflected second membrane through the coupling member;
transferring the representation of the pressure wave from the coupling member to the sensor; and
determining a direction based on a comparison of the representation of deflection of the first and second membranes.

18. The method of detecting the directionality of claim 17, wherein the first membrane and the second membrane are coupled to a housing, the method including:
measuring a relative displacement of one or more of the first membrane or the second membrane with the sensor;
measuring one or more sensed representation of deflection from the sensor;
wherein the one or more sensed representations includes amplitude, magnitude, or phase of the pressure wave.

19. The method of detecting the directionality of claim 17, wherein the vector sensor includes one or more membranes disposed within the channel, the method including:
transmitting a representation of the pressure wave to an adjacent membrane of the one or more membranes disposed within the channel.

20. The method of detecting the directionality of claim 17, wherein the coupling is one or more of a fluid coupling or a mechanical coupling.
